(19) United States
(12) Patent Application Publication
(10) Pub. No.: US 2024/0398150 A1
(43) Pub. Date: Dec. 5, 2024

(54) BEVERAGE PREPARATION MACHINE WITH SIMPLE ERGONOMIC OPENING-CLOSURE

(71) Applicant: SOCIETE DES PRODUITS NESTLE S.A., Vevey (CH)

(72) Inventors: JURGEN KRISTLBAUER, Zollikofen (CH); LAURENT LAGOUCHE, Evian Les Bains (FR)

(21) Appl. No.: 18/698,920

(22) PCT Filed: Oct. 7, 2022
(86) PCT No.: PCT/EP2022/077907

§ 371 Date: Apr. 5, 2024

(30) Foreign Application Priority Data
Oct. 8, 2021 (EP) 21201687.7

(51) Int. Cl. A47J 31/36; A47J 31/22; A47J 31/44

(52) U.S. Cl. CPC A47J 31/3676; A47J 31/4403; A47J 31/22

(57) ABSTRACT

A machine (1) for preparing a beverage (3) •a beverage processing unit (10,20) having a first and a second parts (10, 20) that are movable one relative to the other from a distant to a proximate relative position to form an ingredient mixing seat (11); and •a dampening device being: •operative to dampen the relative movement of the first and second parts (10, 20) moving one relative to the other when the first and second parts (10, 20) are at a relative position that is close to at least one of the distant and proximate relative positions; and •inoperative to dampen the relative movement of the first and second parts (10, 20) moving one relative to the other when the first and second parts (10, 20) are at a relative position that is remote from the first and second relative positions.

### FIELD OF THE INVENTION

The field of the invention pertains to beverage preparation machines which uses thermally conditioned liquid, such as heated and/or cooled liquid. The liquid is typically water or water-based. The machine may be configured to prepare the beverage by passing the liquid through an ingredient of the beverage to be prepared, such as at least one of coffee, tea, cacao, milk, sugar and/or soup ingredient. The ingredient may be supplied within a capsule into the machine. For instance, the liquid is mixed with the ingredient contained in the capsule by centrifuging the capsule while the liquid is passed through the capsule.

For the purpose of the present description, a “beverage” is meant to include any human-consumable liquid substance, such as tea, coffee, hot or cold chocolate, milk, soup, baby food, etc . . . . A “capsule” is meant to include any container such as a packaging for containing a pre-portioned beverage ingredient, e.g. a flavouring ingredient, the packaging forming an enclosure of any material, in particular an airtight or pervious material, porous or non-porous material, e.g. plastic, aluminium, paper, recyclable and/or biodegradable packagings, and of any shape and structure, including soft pods or rigid cartridges for containing the ingredient.

### BACKGROUND ART

Certain beverage preparation machines use capsules containing ingredients to be extracted or to be dissolved and/or ingredients that are stored and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

The preparation of a beverage by using centrifugation is known. Such beverage preparation includes: providing a beverage (flavoring) ingredient, e.g. as powder and/or leaves, in a capsule; circulating liquid into the capsule and rotating the capsule at sufficient speed to ensure interaction of the liquid with the ingredient while creating a gradient of pressure of liquid in the capsule. Such pressure increases gradually from the center towards the periphery of the capsule. As liquid traverses the ingredient, e.g. coffee bed, extraction of the ingredient, e.g. coffee compounds, takes place and a liquid extract is obtained that flows out at the periphery of the capsule. Examples of such systems are disclosed in WO2008/148601, WO 2013/007776, WO 2013/007779 and WO 2013/007780.

Certain beverage ingredients, such as roast and ground coffee or tea, must be brewed with a heated liquid, e.g., hot water, within a particular range of temperature to ensure the full extraction of the ingredients including the capture of the desired aroma compounds. Therefore, the liquid supplied in the brewing unit cannot be overheated to compensate for the temperature losses endured by the liquid after extraction as it would negatively affect the quality of extraction. The range of temperatures for an optimal brewing such as for coffee or tea must be so respected for ensuring the best quality of the final beverage. Furthermore, other quality characteristics of the coffee beverage must be preserved during preparation such as the head of foam called “crema”. It is already known from EP 2393404 to compensate for a temperature loss in a device as described above by using additional heating elements, but these devices are very complex. Advantageous systems to manage the temperatures of the liquid before mixing it with the beverage flavouring ingredient and of the resulting beverage are disclosed in WO 2010/089329, WO 2014/090850 and WO 2020/201469.

Further beverage preparation machines are disclosed in WO 2009/043630 and WO 2011/042401 which disclose semi-automatic opening or closure arrangements for brewing units. The latter publication discloses that the semi-automatic arrangement can be associated with a movement dampener, for example in the form of inertia dampeners, friction dampeners, hydraulic dampeners, air dampeners, magnetic dampeners, in particular spur gears.

There is still a need to provide an economic and/or ergonomic beverage machine with a mixing arrangement and/or improve the reliability of the capsule removal.

### SUMMARY OF THE INVENTION

The invention relates to a machine for preparing a beverage from an ingredient. The beverage preparation machine can be an in-home or out of home machine. The machine may be for the preparation of coffee, tea, chocolate, cacao, milk, soup, baby food, etc . . . .

The beverage preparation typically includes the mixing of a plurality of beverage ingredients, e.g. water and milk powder, and/or the infusion of a beverage ingredient, such as an infusion of ground coffee or tea with water. One or more of such ingredients may be supplied in loose and/or agglomerate powder form and/or in liquid form, in particular in a concentrate form. A carrier or diluent liquid, e.g. water, may be mixed with such ingredient to form the beverage. Typically, a predetermined amount of beverage is formed and dispensed on user-request, which corresponds to a portion (e.g. a serving). The volume of such a serving may be in the range of 15 to 1000 ml such as 25 to 600 ml for instance 40 to 250 ml, e.g. the volume for filling a cup or mug, depending on the type of beverage. Formed and dispensed beverages may be selected from ristrettos, espressos, lungos, cappuccinos, café latte, americano coffees, teas, etc . . . . For example, a coffee machine may be configured for dispensing espressos, e.g. an adjustable volume of 20 to 60 ml per serving, and/or for dispensing lungos, e.g. a volume in the range of 70 to 200 ml per serving, and/or for dispensing americanos, e.g. a volume in the range of 150 to 750 ml.

The ingredient may be supplied into and processed in such machine within in a capsule, e.g. provided with a flange. Such capsule may be of the type described above under the title “Field of the Invention” and/or the capsule may include an ingredient described under the same title. Examples of suitable capsules are disclosed in WO 2008/148601, WO 2008/148604, WO 2008/148646, WO 2008/148650, WO 2008/148656, WO 2008/148834, WO 2011/141532, WO 2011/141535, WO 2013/072239, WO 2013/072297, WO 2013/072326, WO 2015/044400. The capsule may be of the variety commercialised by Nespresso under the brand Vertuo.

The capsule can comprise a capsule body. The capsule body may be symmetric or asymmetric, conical or frusto-conical, pyramidal or frusto-pyramidal, cylindrical or prismatic, spherical or hemispherical or frusto-spherical, domical or frusto-domical. The capsule body may contain the ingredient, e.g. ground coffee, tea or cacao or another beverage ingredient.

The capsule can have a circular peripheral annulus flange, e.g. a flexible or rigid flange, extending from a peripheral part, e.g. an edge or face, of the capsule body.

The machine is configured for preparing a beverage from a flavouring ingredient by mixing water with the flavouring ingredient, e.g. by centrifugally driving such flavouring ingredient with the water.

The machine has a beverage processing unit that includes a first part and a second part that are movable one relative to the other from a distant relative position to a proximate relative position. The first and second parts form in the proximate position an ingredient mixing seat for mixing the ingredient with water and in the distant relative position a passage for insertion of the ingredient into the mixing seat and/or removal of the ingredient from the mixing seat, e.g. upon use.

The machine has a dampening device associated with the processing unit and configured for dampening a relative movement of the first and second parts when moving one relative to the other.

The first part and the second part can be movable in translation and/or in rotation, e.g. about a rotation axis, one relative to the other from a distant relative position to a proximate relative position.

The dampening device is operative to dampen the relative movement of the first and second parts moving one relative to the other when the first and second parts are at a relative position that is close to at least one of the distant and proximate relative positions.

By providing such a dampening arrangement it is possible to relatively move the first and second parts between their proximate and distant positions quickly, e.g. by using an automatic or semi-automatic actuator typically as discussed below, and still avoid excessive end-of-movement shocks, especially shocks that would damage the machine and/or cause significant vibrations through the machine, e.g. vibrations of a magnitude suitable to displace the entire machine and/or interfere with the ingredient handling, e.g. with a removal of an ingredient capsule from the mixing seat.

The first and the second parts may each have a weight that is a fraction of a total weight of such machine, the fraction being in the range of 5 to 95%, for instance 10 to 90%, such as 15 to 85%, e.g. 20 to 80%.

The dampening device is inoperative to dampen the relative movement of the first and second parts moving one relative to the other when the first and second parts are at a relative position that is remote from the first and second relative positions.

The first and second parts moving one relative to the other may be close to at least one of the distant and proximate relative positions when their relative position is closer to said at least one distant and proximate relative positions than 10% of a spacing, e.g. a distance spacing and/or an angular spacing, extending from the distant to the proximate relative positions, such as closer than 5% of the spacing, for instance closer than 2.5% of the spacing, e.g. closer than 1% of the spacing.

The distance spacing can in the range of 1.5 to 7 cm, such 2 to 5 cm.

The angular spacing may be in the range of 20 to 95 deg, such as 30 to 60 deg.

The first and second parts moving one relative to the other may be remote from at least one of the distant and proximate relative positions when their relative position is different to their relative close position.

The dampening device can be operative to dampen the relative movement of the first and second parts when the first and second parts are at a relative position that is close to either the distant relative position or the proximate relative position or to any of the distant and proximate relative positions.

The processing unit may include an automatic or semi-automatic actuator configured to move by urging one part relative to the other part into at least one of the distant and proximate relative positions, in which relative position the dampening device is operative to dampen the relative movement of the first and second parts. For instance, the automatic or semi-automatic actuator is configured to urge the first and second parts into the distant relative position in which the dampening device is operative to dampen the relative movement of the first and second parts.

The automatic or semi-automatic actuator may have at least one of: an electric actuator, e.g. a motor; a pneumatic actuator, e.g. a pneumatic semi-automatic return actuator; and a spring actuator, for instance a return spring actuator, optionally a spring actuator having a blade, torsion, spiral and/or helicoidal spring. For instance, the helicoidal spring has a first end associated with the first part and a second end associated with the second part, e.g. first and/or second ends being allowed to flex or not flex. The actuator may include several such springs e.g. a pair of springs, for instance side-by-side springs.

The dampening device can form an end-of-movement bumper that is stressed, e.g. compressed or stretched or flexed, when the first and second parts reach at least one of their distant and proximate relative positions.

The dampening device may include at least one of: a resilient member, such as a spring or rubber or rubber-like member; a magnetic device; a hydraulic device; and a friction device.

The dampening device can be stationary or mobile relative to one part of the first and second parts, such as directly or indirectly fixed thereto, the other part of the first and second parts may include a member, e.g. a rigid member, that contacts and stresses, e.g. compresses or stretches or flexes, the dampening device when the dampening device is operative to dampen.

The dampening device may have a recess and at least one of the first and second parts may have a member including a protruding part, and or vice-versa, the protruding part entering the recess and contacting the dampening device so as to stress, e.g. compress or stretch or flex, the dampening device when the dampening device is operative to dampen.

The machine can have a foot configured to rest and be stationary on an external support surface, such as a table top or shelf top surface or cabinet top, during beverage preparation, the processing unit and the dampening device being directly or indirectly mounted to the foot. The foot may be fixed to or integral with an outside machine housing and/or with a machine frame.

One part of the first and second parts can be stationary or movable relative to the foot and the other part of the first and second parts can be movable relative to the foot when moving one part relative to the other part.

The dampening device may be movable or stationary relative to one or more of the foot, the first and second parts.

The first and second parts can be both movable relative to the dampening device, the dampening device being movable or stationary relative to foot, when moving one part of the first and second parts relative to the other part.

The dampening device may be stationary relative to one part of the first and second parts, the dampening device being movable or stationary relative to the foot, when moving one part of the first and second parts relative to the other part.

The first part can have a cavity and the second part can have a cover, the cavity and the cover delimiting the seat in the proximate relative position.

Examples of such seats and covers are for instance disclosed in WO2014/096122, WO2014/096123 and WO2020/201469.

The processing unit may have a water feed conduit for feeding said water into the seat and a beverage outlet passage for passing the beverage out of the seat. For example one part of the processing unit, e.g. the second part, having both and/or delimiting both water feed conduit and beverage outlet passage.

The seat may be configured to house the flavouring ingredient supplied within a capsule, for instance a capsule of the type described above and/or provided with a flange.

The beverage processing unit may have at least one capsule inlet piercing element, e.g. a central piercing element, associated with the water feed conduit. For instance, the conduit is delimited by the piercing element, e.g. extending inside the piercing element.

The beverage processing unit can include one or more capsule outlet piercing elements, e.g. a series of spaced apart peripheral piercing elements, associated with the beverage outlet passage. The beverage outlet passage may extend adjacently to the outlet piercing element (s).

The beverage processing unit may be fitted with a capsule transfer device for inserting a capsule the seat and/or removing a capsule from the seat. The capsule transfer device can be associated with a guide for guiding the capsule to and/or from the seat, such as a pair of slides configured to guide the abovementioned flange of the capsule.

Examples of suitable transfer devices are disclosed in WO2012041605, WO 2017/046294 and WO 2017/202746.

The machine may include a fluid line extending from a source of water, e.g. a water tank, to a beverage outlet.

Examples of water tanks are known from the coffee maker Vertuo Next or from WO 2011/083103, WO 2011/089210 and WO 2017/081055.

Such beverage outlet can be located above a beverage dispensing area for receiving a user-recipient, e.g. a mug or a cup, to be filled with beverage. For example, the beverage dispensing area is delimited by a recipient support and/or an outside machine housing.

Examples of recipient supports are disclosed in EP 0 549 887, EP 1 440 639, EP 1 731 065, EP 1 867 260, U.S. Pat. Nos. 5,161,455, 5,353,692, WO 2009/074557, WO 2009/074559, WO 2009/135869, WO 2011/154492, WO 2012/007313, WO 2013/186339, WO 2016/096705, WO 2016/096706, WO 2016/096707 and WO 2020/030740. A suitable support has been commercialised by Nespresso in a coffee maker branded Vertuo Next.

The fluid line may include at least one of: a pump for driving the water from the water source to the seat; and a thermal conditioner such as a heater and/or cooler for thermally conditioning water to be supplied into the seat.

Examples of pumps and their incorporation into beverage machines are disclosed in WO 2009/150030, WO 2010/108700, WO 2011/107574 and WO 2013/098173.

Examples of thermal conditioners can be found in EP 1 253 844, EP 1 380 243 and EP 1 809 151, WO 2010/089329, WO 2014/090850 and WO 2020/201469.

The machine can have a removable ingredient container, such as a waste ingredient collector or a flavouring ingredient supplier. The ingredient container may have an upper compartment for containing sold ingredient and a lower compartment for containing liquid.

Examples of such containers are also known from the coffee maker Vertuo Next or from WO 2009/074559.

### BRIEF DESCRIPTION OF THE DRAWINGS

The invention will now be described with reference to the schematic drawings, wherein:

FIG. 1 is a cross-sectional elongated view of a machine according to the invention with its first and second parts of the processing unit in their proximate position;

FIG. 1a is an enlarged view of a detail 100 of FIG. 1;

FIG. 2 is a perspective view an automatic actuator for actuating the first and second parts of the machine of FIG. 1;

FIG. 3 is a perspective view of a dampening device of the machine of FIG. 1;

FIG. 4 is a cross-sectional view of the machine of FIG. 1 with its first and second parts of the processing unit in their distant position;

FIG. 4a is an enlarged view of a detail 200 of FIG. 1; and

FIG. 5 is a front view of the machine shown in FIG. 4.

### DETAILED DESCRIPTION

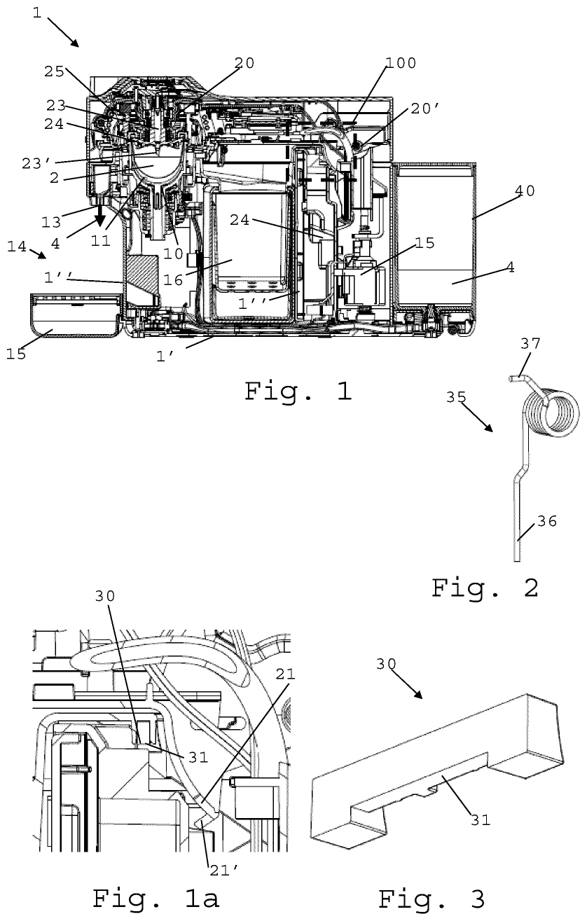

FIGS. 1 to 5, in which the same numeric references generally designate the same elements, illustrate an exemplary embodiment of a machine 1 and elements thereof in accordance with the invention.

Machine 1 is configured for preparing a beverage 3 from a flavouring ingredient 2, e.g. coffee or tea or chocolate or cacao or milk or soup, by mixing water 4 with ingredient 2, for example by centrifugally driving such ingredient 2 with water 4.

Machine 1 includes a beverage processing unit 10,20 having a first part 10 and a second part 20 that are movable one relative to the other from a distant relative position (FIGS. 4, 4a and 5) to a proximate relative position (FIGS. 1 and 1a). First and second parts 10,20 form in the proximate position an ingredient mixing seat 11 for mixing ingredient 2 with water 4 and in the distant relative position a passage 5 for insertion of ingredient 2 into mixing seat 11 and/or removal of ingredient 2 from mixing seat 11.

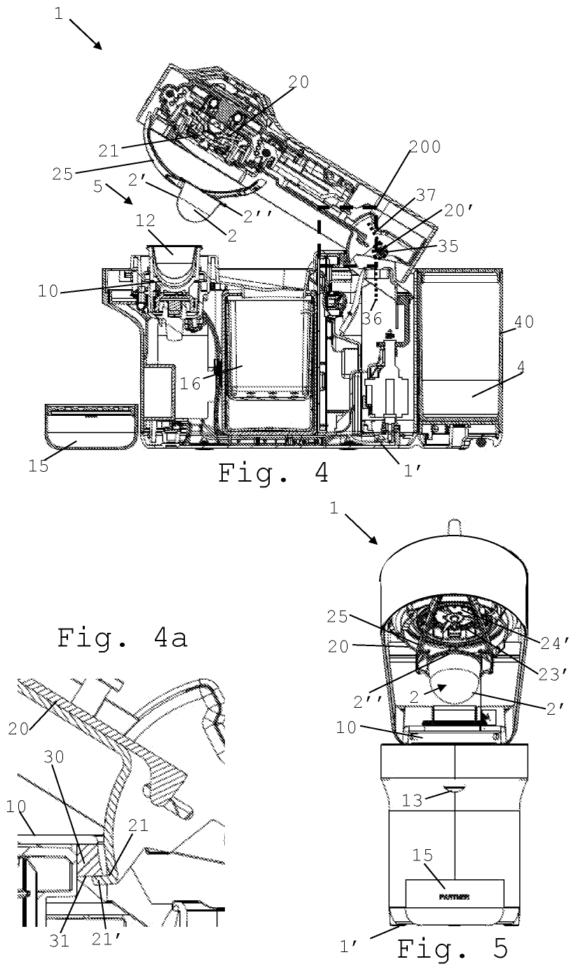

Machine 1 has a dampening device 30 (FIG. 3) associated with processing unit 10,20 and configured for dampening a relative movement of first and second parts 10,20 when moving one relative to the other.

First part 10 and second part 20 may be movable one relative to the other in translation and/or in rotation, e.g. about a rotation axis 20′, from a distant relative position to a proximate relative position.

Dampening device 30 is operative to dampen the relative movement of first and second parts 10,20 moving one relative to the other when first and second parts 10,20 are at a relative position that is close to at least one of the distant and proximate relative positions.

Dampening device 30 is inoperative to dampen the relative movement of first and second parts 10,20 moving one relative to the other when first and second parts 10,20 are at a relative position that is remote from the first and second relative positions.

For instance, first and second parts 10,20 each have a weight that is a fraction of a total weight of such machine 1, the fraction being in the range of 5 to 95%, for example 10 to 90%, such as 15 to 85%, e.g. 20 to 80%.

First and second parts 10,20 moving one relative to the other may be considered to be close to at least one of the distant and proximate relative positions when their relative position is closer to such at least one distant and proximate relative positions than 10% of a spacing, e.g. a distance spacing and/or an angular spacing, extending from the distant relative position to the proximate relative position, such as closer than 5% of the spacing, for instance closer than 2.5% of the spacing, e.g. closer than 1% of the spacing.

First and second parts 10,20 moving one relative to the other may be considered remote from at least one of the distant and proximate relative positions when their relative position is different to their relative close position.

Dampening device 30 can be operative to dampen the relative movement of first and second parts 10,20 when first and second parts 10,20 are at a relative position that is close to either the distant relative position or the proximate relative position or to any of the distant and proximate relative positions.

Processing unit 10,20 may include an automatic or semi-automatic actuator 35 (FIGS. 2 and 4) configured to move by urging one part 20 relative to the other part 10 into at least one of the distant and proximate relative positions, in which relative position dampening device 30 is operative to dampen the relative movement of first and second parts 10,20. Automatic or semi-automatic actuator 35 can be configured to urge first and second parts 10,20 into the distant relative position in which dampening device 30 is operative to dampen the relative movement of first and second parts 10,20.

Automatic or semi-automatic actuator 35 can include at least one of: an electric actuator, e.g. a motor; a pneumatic actuator, e.g. a pneumatic semi-automatic return actuator; and a spring actuator 35, for instance a return spring actuator 35. Such spring actuator 35 may have a blade, torsion, spiral and/or helicoidal spring 35, such as a spring 35 having a first end 36 associated with first part 10 and a second end 37 associated with second part 20.

Dampening device 30 may form an end-of-movement bumper that is stressed, e.g. compressed or stretched or flexed, when first and second parts 10,20 reach at least one of the distant and proximate relative positions.

Dampening device 30 can include at least one of: a resilient member, such as a spring or rubber or rubber-like member; a magnetic device; a hydraulic device; and a friction device.

Dampening device 30 may be stationary or mobile relative to one part 10 of first and second parts 10,20, such as directly or indirectly fixed thereto, the other part 20 of first and second parts 10,20 having a member 21, e.g. a rigid member, that contacts and stresses, e.g. compresses or stretches or flexes, dampening device 30 when dampening device 30 is operative to dampen.

Dampening device 30 may include a recess 31 and at least one of first and second parts 10,20 may include a member 21 having a protruding part 21′, and or vice-versa. Protruding part 21′ may enter the recess 31 and contact dampening device 30 so as to stress, e.g. compress or stretch or flex, dampening device 30 when dampening device 30 is operative to dampen.

Machine can have a foot 1′ configured to rest and be stationary on an external support surface, such as a table top or shelf top surface or cabinet top, during beverage preparation, processing unit 10,20 and dampening device 30 being directly or indirectly mounted to foot 1′, such as a foot 1′ fixed to or integral with an outside machine housing 1″ and/or with a machine frame 1′″.

One part 10 of the first and second parts 10,20 can be stationary or movable relative to foot 1′ and the other part 20 of first and second parts 10,20 can be movable relative to the foot 1′ when moving one part 20 relative to the other part 10.

Dampening device may be movable or stationary relative to one or more of foot 1′, first and second parts 10,20.

The first and second parts can be both movable relative to the dampening device, the dampening device being movable or stationary relative to foot, when moving one part of the first and second parts relative to the other part.

Dampening device 30 may be stationary relative to one part 10 of first and second parts 10,20, dampening device 30 being movable or stationary relative to foot 1′, when moving one part 20 of first and second parts 10,20 relative to the other part 10.

First part 10 can have a cavity 12 and second part 20 can have a cover 22, cavity 12 and cover 22 delimiting seat 11 in the proximate relative position, processing unit 10,20 having a water feed conduit 23 for feeding water 4 into seat 11 and a beverage outlet passage 24 for passing beverage 3 out of seat 11. For example, one part 20 of processing unit 10,20, e.g. second part 20, having both and/or delimiting both water feed conduit 23 and beverage outlet passage 24.

Seat 11 may be configured to house flavouring ingredient 2 supplied within a capsule 2′, e.g. provided with a flange 2″.

Beverage processing unit 10,20 can have at least one capsule inlet piercing element 23′, e.g. a central piercing element 23′, associated with water feed conduit 23. Conduit 23 may be delimited by piercing element 23′, e.g. conduit 23 extending inside piercing element 23′;

Beverage processing unit 10,20 may include one or more capsule outlet piercing elements 24′, e.g. a series of spaced apart peripheral piercing elements 24′, associated with beverage outlet passage 24. Beverage outlet passage 24 may extend adjacently to outlet piercing element(s) 24′

Beverage processing unit 10,20 can be fitted with a capsule transfer device 25 for inserting a capsule 2′ into seat 11 and/or removing a capsule 2′ from seat 11. Capsule transfer device 25 may be associated with a guide for guiding capsule 2′ to and/or from seat 11, such as a pair of slides configured to guide capsule flange 2″.

Machine 1 may include a fluid line 13,23,24,40 extending from a source of water 40, e.g. a water tank, to a beverage outlet 13. Such outlet 13 can be located above a beverage dispensing area 14 for receiving a user-recipient to be filled with beverage 3. Beverage dispensing area 14 may be delimited by a recipient support 15 and/or an outside machine housing 1″.

Fluid line may incorporate at least one of: a pump 16 for driving water 4 from source of water 40 to seat 11; and a thermal conditioner 25 such as a heater and/or cooler for thermally conditioning water 4 to be supplied into seat 11.

Machine 1 can have a removable ingredient container 16, such as a waste ingredient collector 16 or a flavouring ingredient supplier.

1. A machine for preparing a beverage from a flavouring ingredient by mixing water with the flavouring ingredient, such machine comprising:
a beverage processing unit having a first part and a second part that are movable one relative to the other from a distant relative position to a proximate relative position, the first and second parts forming in the proximate position an ingredient mixing seat for mixing said ingredient with water and in the distant relative position a passage for insertion of said ingredient into the mixing seat and/or removal of said ingredient from the mixing seat; and
a dampening device associated with the processing unit and configured for dampening a relative movement of the first and second parts when moving one relative to the other,
the dampening device is:
operative to dampen the relative movement of the first and second parts moving one relative to the other when the first and second parts are at a relative position that is close to at least one of the distant and proximate relative positions; and
inoperative to dampen the relative movement of the first and second parts moving one relative to the other when the first and second parts are at a relative position that is remote from the first and second relative positions.

2. The machine of claim 1, wherein the first and second parts moving one relative to the other are close to at least one of the distant and proximate relative positions when their relative position is closer to said at least one distant and proximate relative positions than 10% of a spacing, e.g. a distance spacing and/or an angular spacing, extending from the distant relative position to the proximate relative position, such as closer than 5% of said spacing.

3. The machine of claim 1, wherein the first and second parts moving one relative to the other are remote from at least one of the distant and proximate relative positions when their relative position is different to their relative close position.

4. The machine of claim 1, wherein the dampening device is operative to dampen the relative movement of the first and second parts when the first and second parts are at a relative position that is close to either the distant relative position or the proximate relative position or to any of the distant and proximate relative positions.

5. The machine of claim 1, wherein the processing unit comprises an automatic or semi-automatic actuator configured to move by urging one part relative to the other part into at least one of the distant and proximate relative positions, in which relative position the dampening device is operative to dampen the relative movement of the first and second parts.

6. The machine of claim 5, wherein the automatic or semi-automatic actuator comprises an electric actuator.

7. The machine of claim 1, wherein the dampening device forms an end-of-movement bumper that is stressed when the first and second parts reach at least one of the distant and proximate relative positions.

8. The machine of claim 1, wherein the dampening device comprises a resilient member.

9. The machine of claim 1, wherein the dampening device is stationary or mobile relative to one part of the first and second parts, the other part of the first and second parts comprising a member that contacts and stresses the dampening device when the dampening device is operative to dampen.

10. The machine of claim 1, wherein the dampening device comprises a recess and at least one of the first and second parts comprises a member having a protruding part, and or vice-versa, the protruding part entering the recess and contacting the dampening device so as to stress the dampening device when the dampening device is operative to dampen.

11. The machine of claim 1, which has a foot configured to rest and be stationary on an external support surface during beverage preparation, the processing unit and the dampening device being directly or indirectly mounted to the foot.

12. The machine of claim 11, wherein one part of the first and second parts is stationary or movable relative to the foot and the other part of the first and second parts is movable relative to the foot when moving one part relative to the other part.

13. The machine of claim 12, wherein the dampening device is movable or stationary relative to one or more of the foot.

14. The machine of claim 1, wherein the first part has a cavity and the second part has a cover, the cavity and the cover defining the seat in the proximate relative position, the processing unit comprising a water feed conduit for feeding said water into the seat and a beverage outlet passage for passing said beverage out of the seat.

15. The machine of claim 1, which comprises:
a fluid line extending from a source of water to a beverage outlet; and
a removable ingredient container.
